(19) United States
(12) Patent Application Publication
(10) Pub. No.: US 2026/0326342 A1
(43) Pub. Date: Oct. 22, 2026

(54) PINLESS SLURRY MIXER GENERATING ENHANCED TURBULENCE

(71) Applicant: UNITED STATES GYPSUM COMPANY, Chicago, IL (US)

(72) Inventors: Te Hua LAU, Glenview (IL); Sunil Thansingh SHEKHAWAT, Puzhal Chennai (IN); Sanjay Kumar DUBEY, Tirupati (IN); Chittimilla RAJESH, Tirupati (IN); Jacek OSINSKI, Opole (PL)

(21) Appl. No.: 19/424,704

(22) Filed: Dec. 18, 2025

Related U.S. Application Data
(60) Provisional application No. 63/791,144, filed on Apr. 18, 2025.

(51) Int. Cl. B28C 5/16

(52) U.S. Cl. CPC B28C 5/166

(57) ABSTRACT

A gypsum slurry mixer includes a mixer housing including an upper plate, a lower plate and an annular wall collectively defining a mixer interior chamber, a rotor disc rotatable within the interior chamber, the rotor disc connected to a hub being connected to a power source for rotation of the rotor disc within the mixer interior chamber, and a pair of scrapers secured to the rotor disc and positioned on the disc to define a separation space therebetween that accommodates the hub.

### RELATED APPLICATION

The present application is a Non-Provisional of, and claims 35 U.S.C. 119 priority from, US Provisional Serial No. 63/791,144 filed Apr. 18, 2025, the entire contents of which are incorporated by reference herein.

### BACKGROUND

The present disclosure generally relates to a method and apparatus for preparing gypsum products from starting materials including calcined gypsum and water, and more particularly relates to an improved apparatus for use in conjunction with a slurry mixer used in supplying agitated gypsum slurry to a wallboard production line.

It is well known to produce gypsum products by dispersing calcined gypsum in water to form a slurry, then casting the slurry into a desired shaped mold or onto a moving surface, and allowing the slurry to set to form hardened gypsum by reaction of the calcined gypsum (calcium sulfate hemihydrite or anhydrite) with the water to form hydrated gypsum (calcium sulfate dihydrate). In preferred embodiments, for producing gypsum wallboard panels, the slurry is poured upon a layer of face paper moving along a conveyor line, and after the slurry is deposited and spread, a second layer of backing paper is oriented on an upper surface of the slurry. Subsequently, the paper layers and slurry are formed into a desired panel shape prior to the slurry setting or hardening.

Prior apparatus and methods for addressing some of the operational problems associated with the production of foamed gypsum are disclosed in commonly-assigned U.S. Pat. Nos. 5,638,635; 5,643,510; 6,494,609; and 6,874,930; all of which are incorporated by reference. The present invention relates generally to mixers used in the formulation of gypsum slurries in the production of gypsum wallboard.

A gypsum wallboard mixer typically includes a housing defining a mixing chamber with inlets for receiving sources of calcined gypsum and water, among other additives well known in the art. The mixer includes an impeller or other type of agitator for agitating the contents to be mixed into a mixture or slurry. Vertically projecting lugs attached to the impeller are known as pins. Such mixers typically have a preferably rectangular discharge gate or slot with a cutoff block or door. The discharge gate controls the flow of slurry from the mixer, but is difficult to adjust to change slurry flow when product requirements change, such as when thicker or thinner wallboard is desired. A suitable depiction of such a prior art mixer is in US 10,011,045, the contents of which are incorporated by reference herein.

Another type of gypsum slurry mixer is also conventionally used and depicted as a “scraper mixer” or “pinless mixer”. In such a device, a rotating disc is provided with at least one linearly extending scraper attached to the disc. As the disk and scraper are rotated within an internal mixer chamber having a supply of gypsum slurry, the scraper agitates the slurry. In some types of mixers, there are upper and lower scrapers. One such pinless mixer is disclosed in US 10,589,444. One perceived drawback of such pinless mixers is the tendency for clogs, lumps or clumps of unmixed or incompletely mixed slurry to collect near the scrapers or their support structure.

The above-described pinless mixer has advantages over conventional pin mixers. However, drawbacks remain in that there is still a perceived need in the art for an improved, high power mixer which creates enhanced turbulence or shear in the slurry being mixed, as well as reduced lumping caused by localized premature setting of gypsum particles within the slurry. Such enhanced performance is desired to obtain more thorough slurry mixing.

### SUMMARY

The above-listed need is met or exceeded by the present gypsum slurry mixer which features the use of segmented scraper members configured and positioned to enhance mixing turbulence, nonlaminar flow and enhanced shear forces operating on the slurry within the mixer. As a result, slurry rheology between the main rotor and scraper segments is improved. A feature of the present mixer design is that internal mixer shear forces provide improved mixing and reduced lump buildup, especially near a top area of the mixer. In the present mixer, the segmented scrapers are positioned for disrupting the laminar circular flow of the slurry below the top mixer cover. This construction leads to more turbulent slurry mixing, enhanced shear forces and reduced lump buildup, the latter being a constant concern of mixer designers and operators. The above-listed need is also met or exceeded by versions of the present gypsum slurry mixer which feature non-segmented scraper members that are positioned adjacent to but not affixed to the central rotor hub.

Advantageously, a first mixer scraper section is attached to a central rotor hub. A second mixer scraper section is attached to a main rotor so that a distance between the scraper sections is sufficiently narrow to force the slurry through a narrow channel, increasing local slurry velocity and promoting the above-described turbulence and lump prevention.

A distance between a top of a scraper and an adjacent mixer wall may be selected as being less than 5 mm. Also preferred, the top scraper profile is shaped to match a concave curvature of an insert located in the circumference of the side wall and the bottom of the mixer top cover.

Optionally, the segmented scrapers are positioned to be secured only to the rotating disc and not to the central hub. Preferably, the scrapers extend generally parallel to a line bisecting the hub, and are secured in fixed, vertically-spaced relation to the rotating disc by vertically depending legs. To avoid collecting clumps or lumps of unmixed or incompletely mixed gypsum slurry, the legs are positioned on the rotary disc closer to an inner end of each scraper than an outer end. A result of this configuration is that the outer or free end of each scraper is relatively cantilevered relative to the inner end. Since dry slurry ingredients are typically inserted into the mixer interior chamber closer to an outer periphery, the absence of scraper legs in this region significantly reduces the chance for creation of unwanted slurry lumps or clumps.

More specifically, a gypsum slurry mixer includes a mixer housing including an upper plate, a lower plate and an annular wall collectively defining a mixer interior chamber, a rotor disc rotatable within the interior chamber, the rotor disc connected to a hub being connected to a power source for rotation of the rotor disc within the mixer interior chamber, and a pair of scrapers secured to the rotor disc and positioned on the disc to define a separation space therebetween that accommodates the hub.

As an optional feature, each scraper has an inner end disposed closer to the hub and an opposite outer end extending towards a peripheral edge of the disc, and the outer ends of the scrapers extend in opposite directions from each other. Preferably, the outer ends of the scrapers extend to the peripheral edge of the disc.

Advantageously, each scraper is supported by at least one leg, each leg being closer to an inner end than to an outer end of the scraper. Preferably, each leg is secured to an inner half of the scraper. In a preferred option, a pair of the legs is positioned to engage the disc within a distance defined by a diameter of the hub.

As an option, the scrapers are parallel to each other with the hub therebetween.

As an option, the mixer includes an upper radiused junction of the upper plate and the annular wall at the interior chamber, and each scraper has a radiused end configured for complementary rotating movement relative to the radiused junction.

As an option, each scraper has an upper surface with a wear resistant member. In a preferred option, the wear resistant member is removable from the scraper.

As another option, a water line is connected to the mixer housing and in fluid communication with at least one nozzle constructed and arranged for directing a pressurized stream of water towards at least one of the scrapers.

As an option, a gypsum slurry mixer is provided, including, a mixer housing including an upper plate, a lower plate and an annular wall collectively defining a mixer interior chamber, the mixer includes an upper radiused junction of the upper plate and the annular wall at the interior chamber, a rotor disc rotatable within the interior chamber, the rotor disc connected to a hub being connected to a power source for rotation of the rotor disc within the mixer interior chamber, a pair of scrapers connected to the disc and each extending towards a periphery of the disc, and each scraper being supported upon the rotor disc by at least one leg, and having an upper surface with an outer end radiused to be complementary to the radiused junction.

As an option, the scrapers are oriented parallel to each other and define a separation space that accommodates the hub.

As an option, each scraper has an upper surface with a wear resistant member.

As an option, the at least one leg is a pair of legs located closer to an inner end of the scraper than to an outer end.

In yet another aspect, a gypsum slurry mixer is provided, including a mixer housing including an upper plate, a lower plate and an annular wall collectively defining a mixer interior chamber, a rotor disc rotatable within the interior chamber, the rotor disc connected to a hub being connected to a power source for rotation of the rotor disc within the mixer interior chamber, at least one first scraper connected to the hub and extending tangentially thereto; and at least one second scraper, separate from the at least one first scraper, each second scraper connected to the rotor disc at an angle to the at least one first scraper and oriented on the disc relative to each first scraper to define a restricted slurry flow channel therebetween.

### BRIEF DESCRIPTION OF THE DRAWINGS

FIG. 1 is a fragmentary top perspective view of the present mixer;

FIG. 2 is an enlarged, fragmentary cross-section of the mixer shown in FIG. 1;

FIG. 3 is an overhead plan view of a rotor of the mixer of FIG. 1;

FIG. 4 is a cross-section taken along the line 4-4 of FIG. 3 and in the direction generally indicated;

FIG. 5 is a fragmentary top perspective view of an alternate mixer;

FIG. 5A is a fragmentary side vertical section of the mixer shown in FIG. 5;

FIG. 6 is a an enlarged, fragmentary cross-section of the mixer shown in FIG. 5;

FIG. 7 is an overhead plan view of the rotor of the mixer of FIG. 5;

FIG. 8 is a cross-section taken along the line 8-8 of FIG. 7 and in the direction generally indicated;

FIG. 9 is a top perspective view of a third option of the present mixer;

FIG. 10 is a top plan view of the mixer of FIG. 9;

FIG. 11 is a vertical cross section of one of the scrapers seen in FIG. 10 taken along the line 11-11 in the direction generally indicated;

FIG. 12 is an enlarged fragmentary cross-section taken along the line 12-12 of the mixer of FIG. 10 and in the direction generally indicated; and

FIG. 13 is a fragmentary side elevation of a mixer scraper of FIG. 10.

### DETAILED DESCRIPTION

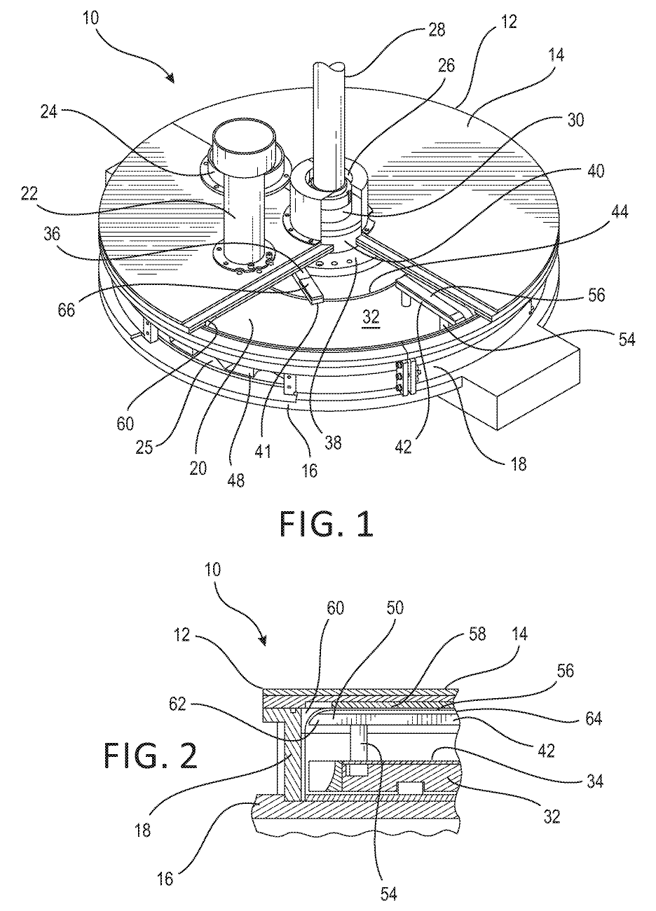

Referring now to FIGS. 1 and 2, a gypsum slurry mixer is generally designated 10, and includes a mixer housing 12 made up of an upper plate 14, a lower plate 16 and an annular wall 18 separating the upper and lower plates and collectively defining a mixer interior chamber 20. As is known in the art, the mixer housing 12 is assembled by welding and/or the use of fasteners. An inlet tube 22 is attached to the upper plate 14 and is in fluid communication with the interior chamber 20 for introducing water into the interior chamber. Also, a separate inlet opening 24 in the upper plate 14 is also in fluid communication with the interior chamber 20 and allows entry of dry gypsum wallboard slurry ingredients as are known in the art. A mixer outlet 25 is provided for sending the mixed slurry from the mixer 10 for delivery upon a moving sheet of face paper as is known in the art.

While not shown here, it is contemplated that the upper plate 14 is optionally configured to have additional, designated inlet ports for the entry of other additives and/or foam used in the production of gypsum wallboard slurry as is well known in the art. In the present application, it will be understood that the terms “gypsum slurry” and “gypsum wallboard slurry” are interchangeable.

A central or axial opening 26 in the upper plate 14 accommodates a drive shaft 28 whereby a motor (not shown) powers a hub 30 connected to a rotor disc 32. The rotor disc 32 is rotatable under power from the drive shaft 28. In the present mixer 10, a contemplated preferred speed of the rotor disc 32 is in the range of 350-450 rpm. Also, the rotor disc 32 has an upper surface 34.

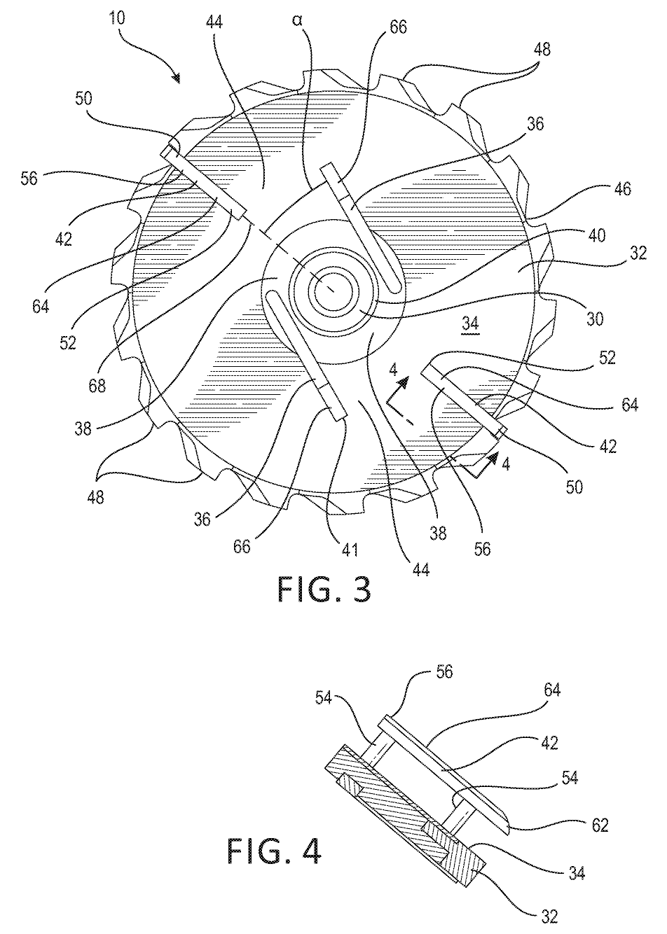

Referring now to FIGS. 1-4, at least one first scraper 36 is connected to the hub 30, preferably to a hub flange 38 (FIG. 3) and extends tangentially to a central, vertically-projecting boss 40 of the hub. Each scraper 36, which is contemplated as being optionally provided as a unit or in segments, passes in close proximity to the boss 40. Preferably, while the number may vary to suit the application, there is a pair of first scrapers 36, each preferably located opposite each other on the hub 30. Also, preferably, the first scrapers 36 are mounted parallel to each other on the hub 30. Another factor of the placement of the first scrapers 36 is that each scraper has a free end 41, and in the preferred embodiment of the present mixer, the free ends of the two first scrapers point in opposite direction to each other, and towards the annular wall 18.

In addition to the first scrapers 36, the mixer 10 includes at least one second scraper 42, separate from the first scraper and connected to the rotor disc 32. Like the first scraper 36, while the number may vary to suit the application, there is a pair of second scrapers 42, also it is contemplated that the second scraper is optionally provided as a unit or in segments,. Also, it is preferred that the second scrapers 42 are mounted to the rotor disc 32 at an angle to a corresponding one of the first scrapers 36. The arrangement of the first and second scrapers 36, 42 on the rotor disc 32 is such that they define a restricted slurry flow channel 44 therebetween.

More specifically, the rotor disc 32 has an outer perimeter or outer edge 46 having a “sawtooth” or lobed profile with a plurality of angled, circumferentially-spaced projections 48. The projections 48 are designed to enhance turbulence within the mixer interior chamber 20. Due to the abrasive nature of the gypsum wallboard slurry, the projections 48 become abraded during operation, and are configured for being removable from the rotor disc 32.

Each second scraper 42 features an outer end 50 located adjacent the outer perimeter, and an inner end 52 directed toward the hub 30. As is the first scraper 36, the second scraper 42 is made of rigid, durable material, such as stainless steel or the like. As seen in FIGS. 1, 2 and 4, each second scraper 42 is supported above the rotor disc 32, and more specifically above the upper surface 34 of the disc by at least one and preferably a pair of legs 54. The legs 54 are constructed and arranged for supporting the second scraper 42 relative to the rotor disc 32 to withstand the significant operational torquing forces.

As seen in FIG. 2, the legs 54 are dimensioned to place or support each second scraper 42, from the rotor disc 32 so that an upper surface 56 of the second scraper is slidingly adjacent an underside 58 of the upper plate 14. In other words, a height of the second scraper 42 plus a thickness of the rotor disc 30 is approximately equal to a height of the annular wall 18.

To avoid unwanted “dead spots” in the flow of the slurry within the mixer interior chamber 20 which have been known to cause premature set lumps in the slurry, the mixer 10 preferably includes an upper annular radiused junction 60 of the upper plate 14 and the annular wall 18 at the interior chamber 20. Also, it is preferred that the legs 54 are positioned so as to not pass directly under the inlet opening 24 so that the legs avoid impact from the incoming slurry ingredients while the rotor disc 30 is rotating. Further, each second scraper 42 has a radiused formation 62 at the outer end 50 that is configured for complementary rotating movement relative to the radiused junction 60. As seen in FIG. 2, there is a small clearance between the radiused junction 60 and the radiused formation 62 on the second scraper 42 that prevents the formation of unwanted dead spots within the mixer interior chamber 20. While other spacings are contemplated depending on the application, a preferred spacing between the second scraper 42 and the underside 58 of the upper plate 14 is 2 mm.

In view of the abrasive nature of the slurry, in a preferred embodiment of the present mixer, each second scraper 42 has the upper surface 56 provided with a wear resistant member 64 preferably made of material that is more durable than that used to form the second scraper. Also, upon experiencing significant wear, the wear resistant member 64 is preferably removable. Alternately, the entire second scraper 42 is removable. Optionally, the first scrapers 36 are also each provided with a removable wear resistant member 66. It is further preferred that any internal surfaces of the mixer 10 that are directly exposed to the slurry are provided with removable or consumable wear-resistant materials similar to members 64, 66.

Referring now to FIG. 3, in a preferred embodiment of the present mixer, the second scrapers 42 are mounted on the rotor disc 32 to be aligned along a line 68 bisecting the hub 30. Also, it will be seen that each first scraper 36 forms an obtuse angle α relative to the second scraper 42 when viewed from above. As the rotor disc 32 and the first and second scrapers 36, 42 rotate in unison within the mixer interior chamber 20, enhanced shear forces are generated in the slurry, portions of which are forced through the restricted flow channel 44.

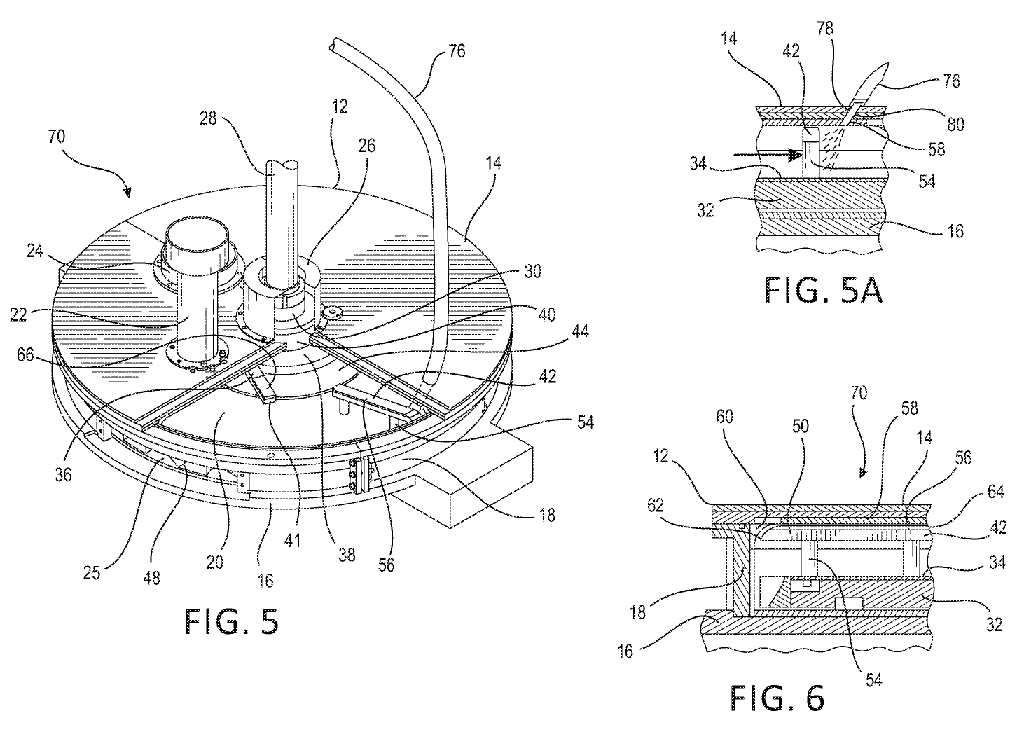

Referring now to FIGS. 5-8, a second option of the present gypsum slurry mixer is generally designated 70. Components shared with the mixer 10 are designated with identical reference numbers. A main difference featured in the mixer 70 compared to the mixer 10 is the position of the second scrapers 42.

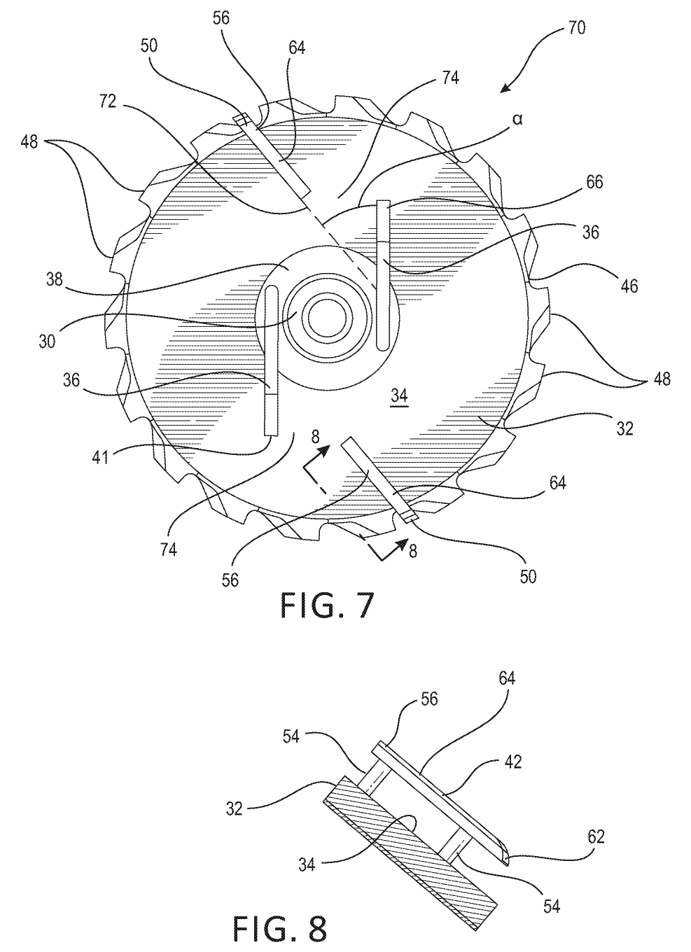

As seen in FIG. 7, the second scrapers 42 are mounted to the rotor disc 32 along a line 72 being generally tangential to the hub 30. As such, a different restricted flow channel 74 is defined compared to the flow channel 44 in FIG. 3. However, as is the case with the mixer 10, in the mixer 70, the disposition of the first scrapers 36 and the second scrapers 42 is such that enhanced slurry agitation, nonlaminar flow and shear forces are generated, resulting in improved mixing compared to conventional gypsum wallboard slurry mixers. Also, it is contemplated that the angle α may vary between the mixers 10 and 70.

Referring again to FIG. 5 and also to FIG. 5A, another feature of the mixer 70, as well as the mixer 10, is a water line 76 that is connected to the upper plate 14 at an opening 78 in the plate. A nozzle 80 is in fluid communication with the water line 76 and is constructed and arranged to dispense a pressurized stream of water on the second scraper 42. More specifically, the pressurized stream of water is directed at a forward edge of the scraper 42 as seen in FIG. 5A, which impacts the scraper in a direction opposite that of the direction of rotor travel, indicated by the arrow.

It has been found that, in some applications, dry gypsum slurry ingredients entering the mixer interior chamber 20 through the inlet tube, before they are fully mixed with water, can form clumps around the second scrapers 42 and/or the support legs 54. In some cases, these clumps become difficult to fully incorporate into the gypsum slurry. As such, the use of the pressurized water streams as described above prevent the formation of these unwanted clumps. Also, when the nozzles 80 are used to wash the second scrapers 42 and/or the legs 54, it is contemplated that the amount of water typically added to the gypsum mixer interior chamber 20 to form the wallboard slurry is proportionately reduced, so that the desired slurry viscosity is maintained. It is further contemplated that multiple nozzles 80 are connected to the water line 76 for similarly washing the first scrapers 36 along with the second scrapers 42 and/or the legs 54.

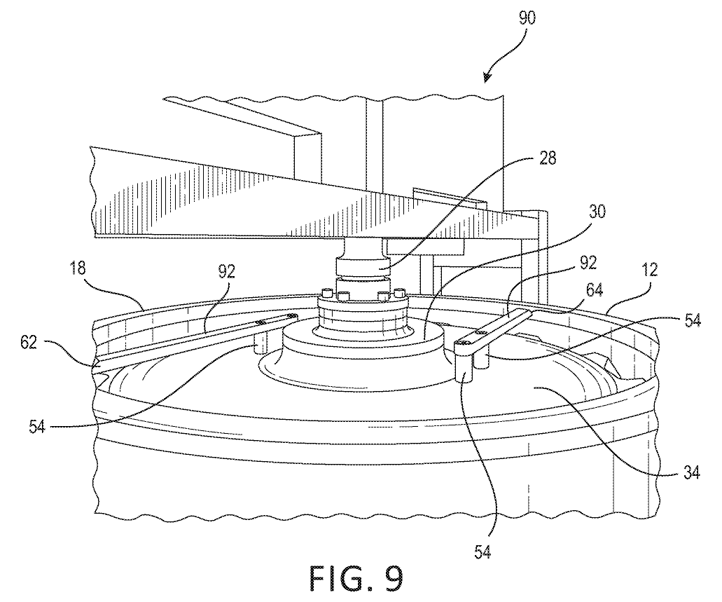

Referring now to FIGS. 9-13, another option of the present mixer is generally designated 90. Components shared with the mixer 10 are designated with identical reference numbers. A feature of the mixer 90 is that instead of the scrapers 36, 42, the former secured to the hub 30 and the latter supported near the disc outer edge 46, there are at least two scrapers 92, both secured to the rotor disc 32 and positioned on the disc to define a separation space “D” (FIG. 10) therebetween that accommodates the hub 30.

Each of the scrapers 92 has an inner end 94 disposed closer to the hub 30 and an opposite free end 96 extending towards the peripheral edge 46 of the disc 32. Also, the free ends 96 of the scrapers 92 extend in opposite directions from each other. Preferably, the free ends 96 extend to the peripheral edge 46 of the disc 32. It is contemplated that the peripheral edge 46 of the disc 32 optionally includes the angled projections 48 of FIG. 3.

A feature of the scrapers 92 is that each is supported by at least one leg 54, however each leg is located closer to the inner end 94 than to the outer scraper end 96. More preferably, there is a pair of legs 54, each leg is secured to an inner half of the corresponding scraper 92. In other words, the legs 54 are positioned to engage the rotor disc 32 within a distance defined by a diameter of the hub 30.

As seen in FIG. 10, the scrapers 92 are preferably parallel to each other with the hub 30 therebetween. However, it is contemplated that the angular orientation and/or position of the scrapers 92 on the rotor disc 32 may vary from that depicted depending on the application. It is considered more important to the operation of the mixer 90 that the legs 54 are positioned closer to the inner scraper ends 94 and away from the opposite, free ends 96 to promote more complete mixing of the slurry, and the prevention of accumulated lumps or clumps of relatively unmixed gypsum slurry in close proximity to the legs 54.

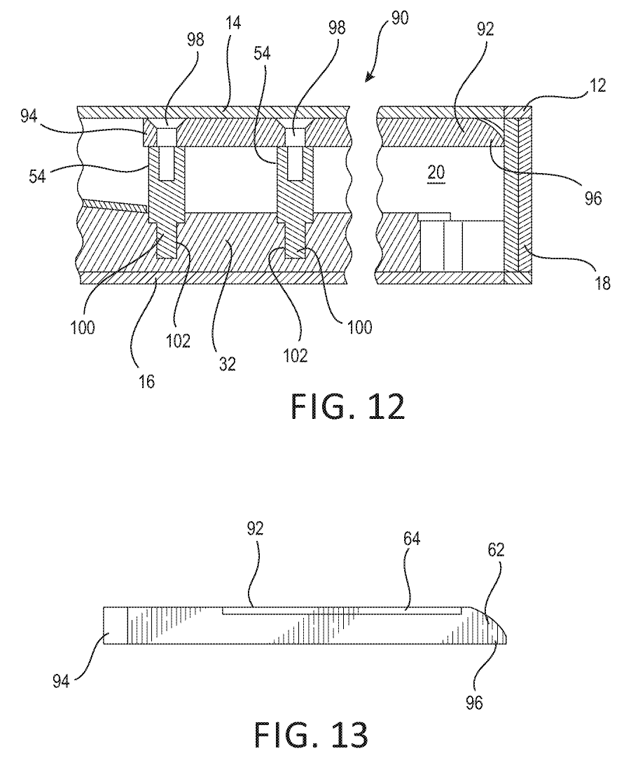

Referring now to FIGS. 12 and 13, similar to the mixer 10, the mixer 90 includes the upper radiused junction 60 of the upper plate 14 and the annular wall 18 at the interior chamber 20, and each scraper 92 has a radiused end 62 at the free end 96 that is configured for complementary rotating movement relative to the radiused junction 60. Such construction is intended to prevent the accumulation lumps or clumps of prematurely set or incompletely mixed gypsum slurry in this region of the mixer 90.

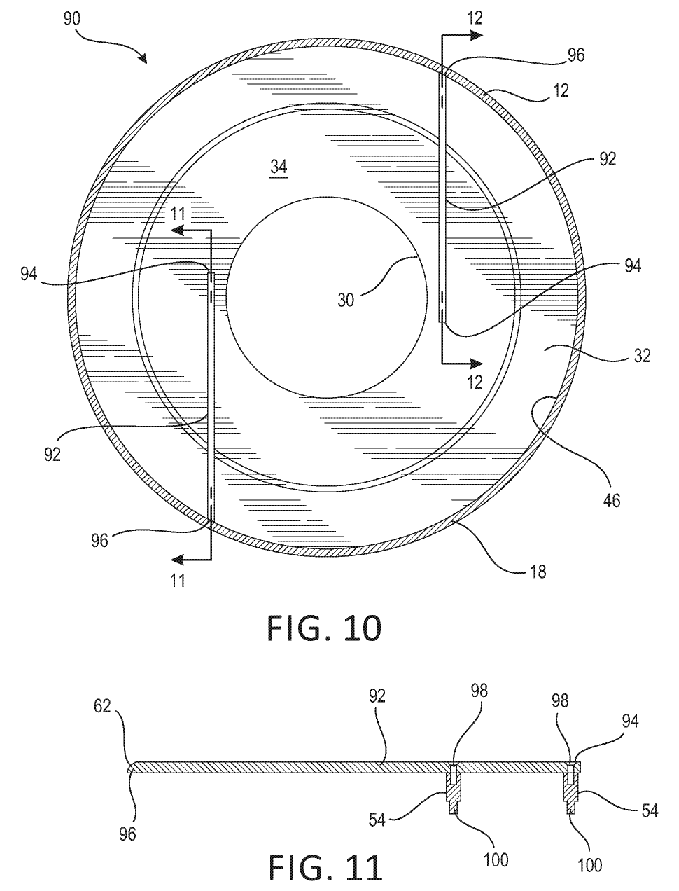

As seen in FIGS. 11 and 12, in both the mixers 10 and 90, the scrapers 36, 42, 92 are secured to the respective legs 54 using fasteners 98, preferably threaded fasteners such as screws or bolts. However, other fastening techniques, such as welding or chemical adhesives are contemplated, depending on the application. Furthermore, each leg 54 has a reduced diameter lower tip 100 that is engageable in a corresponding socket 102 in the rotor disc 32. The tips 100 of the legs 54 are preferably threadably engaged in the sockets 102 and are optionally further secured in place using chemical adhesives or the like, depending on the application.

Also, it will be understood that each of the scrapers 92 is optionally equipped with at least one wear resistant member 64, 66 on the upper surface 56. Also, similar to the mixer 10, the wear resistant members 64, 66 are preferably removable from the scraper to be readily exchanged when worn.

Another optional feature of the mixer 90 is the water line 76 connected to the mixer housing 12 and in fluid communication with at least one nozzle 80 constructed and arranged for directing a pressurized stream of water towards at least one of the scrapers 92.

While particular options of the present pinless slurry mixer with enhanced turbulence have been described herein with various parameters, it will be appreciated by those skilled in the art that changes and modifications may be made thereto without departing from the invention in its broader aspects and as set forth in the following claims.

1. A gypsum slurry mixer, comprising:
a mixer housing including an upper plate, a lower plate and an annular wall collectively, defining a mixer interior chamber;
a rotor disc rotatable within said mixer interior chamber;
said rotor disc connected to a hub, said hub being connected to a power source for rotation of said rotor disc within said mixer interior chamber; and
a pair of scrapers secured to said rotor disc and positioned on said disc to define a separation space therebetween that accommodates said hub.

2. The slurry mixer of claim 1, wherein each said scraper has an inner end disposed closer to said hub and an opposite free end extending towards a peripheral edge of said disc, and said free ends of said pair of scrapers extend in opposite directions from each other.

3. The slurry mixer of claim 2, wherein said free ends of said scrapers extend to the peripheral edge of said disc.

4. The slurry mixer of claim 1, wherein each said scraper is supported by at least one leg, each said leg being closer to an inner end than to an outer end of said scraper.

5. The slurry mixer of claim 3, wherein each said leg is secured to an inner half of each said scraper.

6. The slurry mixer of claim 4, further including a pair of said legs positioned to engage said disc within a distance defined by a diameter of said hub.

7. The slurry mixer of claim 1, wherein said scrapers are parallel to each other with said hub therebetween.

8. The slurry mixer of claim 1, wherein said mixer includes an upper radiused junction of said upper plate and said annular wall at said interior chamber, and each said scraper has a radiused end configured for complementary rotating movement relative to said radiused junction.

9. The slurry mixer of claim 1, wherein each said scraper has an upper surface with a wear resistant member.

10. The slurry mixer of claim 9, wherein each said wear resistant member is removable from said scraper.

11. The slurry mixer of claim 1, further including a water line connected to said mixer housing and in fluid communication with at least one nozzle constructed and arranged for directing a pressurized stream of water towards said at least one scraper.

12. A gypsum slurry mixer, comprising:
a mixer housing including an upper plate, a lower plate and an annular wall collectively defining a mixer interior chamber, said mixer includes an upper radiused junction of said upper plate and said annular wall at said interior chamber;
a rotor disc rotatable within said interior chamber;
said rotor disc connected to a hub, said hub being connected to a power source for rotation of said rotor disc within said mixer interior chamber;
a pair of scrapers connected to said disc and each extending towards a periphery of said disc; and
each said scraper being supported upon said rotor disc by at least one leg, and having an upper surface with an outer end radiused to be complementary to said radiused junction.

13. The gypsum slurry mixer of claim 12, wherein said scrapers are oriented parallel to each other and define a separation space that accommodates said hub.

14. The gypsum slurry mixer of claim 12, wherein each said scraper has an upper surface with a wear resistant member.

15. The gypsum slurry mixer of claim 12, wherein said at least one leg is a pair of said legs located closer to an inner end of said scraper than to an outer end.

16. A gypsum slurry mixer, comprising:
a mixer housing including an upper plate, a lower plate and an annular wall collectively defining a mixer interior chamber;
a rotor disc rotatable within said interior chamber;
said rotor disc connected to a hub, said hub being connected to a power source for rotation of said rotor disc within said mixer interior chamber;
at least one first scraper connected to said hub and extending tangentially thereto; and
at least one second scraper, separate from said at least one first scraper, each said second scraper connected to said rotor disc at an angle to said at least one first scraper and oriented on said disc relative to each said first scraper to define a restricted slurry flow channel therebetween.
